(19) United States
(12) Patent Application Publication
(10) Pub. No.: US 2026/0010977 A1
(43) Pub. Date: Jan. 8, 2026

(54) IMAGE FILTER PROCESSING METHOD AND SYSTEM, APPARATUS, AND STORAGE MEDIUM

(71) Applicant: SHANGHAI HODE INFORMATION TECHNOLOGY CO., LTD., Shanghai (CN)

(72) Inventors: Yingfan ZHANG, Shanghai (CN); Tianxiao YE, Shanghai (CN)

(21) Appl. No.: 19/249,791

(22) Filed: Jun. 25, 2025

(30) Foreign Application Priority Data
Jul. 4, 2024 (CN) 202410888609.0

(51) Int. Cl. G06T 5/10

(52) U.S. Cl. CPC G06T 5/10; G06T 2207/20201

(57) ABSTRACT

The application discloses an image filter processing method. The method includes: performing a Lookahead precoding on a to-be-processed image, and collecting an intra prediction cost in Lookahead of a region covered by a current filter unit before filtering starts; and performing a filter processing on the filter unit, obtaining an inter prediction cost in a filtering process, and adjusting a filter strength on the filter unit based on magnitudes of the intra prediction cost and the inter prediction cost. The application further discloses an image filter processing system, an electronic apparatus, and a computer-readable storage medium.

### CROSS REFERENCE TO RELATED APPLICATION

The application claims priority to Chinese Patent Application No. 202410888609.0, filed on Jul. 14, 2024, which is incorporated herein by reference in its entirety.

### TECHNICAL FIELD

The application relates to the field of video coding technologies, and in particular, to an image filter processing method and system, an electronic apparatus, and a computer-readable storage medium.

### BACKGROUND

Current video coding standards are all formulated based on a hybrid coding framework. In the framework, each frame in a video is first divided into largest coding units (LCU) of a fixed size, and may be further divided into coding units (CU) of variable sizes. For each CU, a predicted image is first obtained by using an inter or intra prediction technology. A difference between the predicted image and a raw image, also referred to as a residual, is transformed and quantized, and then sent to an entropy encoder for coding. Then through inverse quantization and inverse transformation, reconstruction is performed based on the predicted image. Finally, a reconstructed image is obtained through a loop filtering. The reconstructed image may enter a coded (reconstructed) image buffer in the encoder as a reference image for inter prediction in a subsequent coding frame.

Motion-compensated temporal filtering (MCTF) is a video preprocessing technology implemented in multiple encoders in recent years. In the algorithm, before coding starts, relatively important frames (for example, I frames and P frames) in a mini-GOP of a frame sequence are selected as filtered frames. In addition, several front-to-back adjacent frames on a display sequence of the filtered frames are selected as reference frames. The filtered frame is divided into filter units of a fixed size (for example, 16×16 or 32×32), and motion search is successively performed on all reference frames for each filter unit to obtain a motion vector, and each pixel in the filtered frame is weighted by using a motion compensation unit.

Temporal filtering is initially used for video denoising. For extracting multiple groups of pixel values in different video frames in a same content region in the video, a low-pass filter or a band-pass filter is designed to remove noise generated in video production and propagation, thereby improving video quality. For a video coding field, compression efficiency is improved mainly by using filtering, so that content of a reference frame of the inter prediction and a referenced frame in a coding process is closer to each other, thereby improving accuracy and compression efficiency of the inter prediction. However, for the filtered frame, a filter distortion is naturally introduced due to different content before and after filtering, therefore, compression efficiency is generally reduced. In conclusion, temporal filtering in video coding may cause a reduction in compression efficiency of the filtered frame, while compression efficiency of another inter reference frame is improved. By filtering only a few frames (for example, I frames and P frames) in a filter sequence that are referenced more frequently, an overall compression efficiency can be improved.

However, in an actual coding procedure, if a distortion of the intra prediction is lower than that of the inter prediction, a coding unit in the inter reference frame may alternatively selectively use the intra prediction for coding. In this case, an expected intra prediction benefit does not exist, but a filtering loss has been caused. Thus, temporal filtering leads to a reduction in the overall compression efficiency. However, a motion-compensated temporal filtering needs to be completed before coding starts. Therefore, there is no way to avoid this loss at present.

### SUMMARY

A main purpose of this application is to provide an image filter processing method and system, an electronic apparatus, and a computer-readable storage medium, aiming to solve a problem about how to reduce a compression efficiency loss caused by temporal filtering and improve overall video compression efficiency.

To achieve the foregoing objective, embodiments of this application provide an image filter processing method. The method includes:
performing a Lookahead precoding on a to-be-processed image, and collecting an intra prediction cost in Lookahead of a region covered by a current filter unit before filtering starts; and
performing a filter processing on the filter unit, obtaining an inter prediction cost in a filtering process, and adjusting a filter strength on the filter unit based on magnitudes of the intra prediction cost and the inter prediction cost.

Optionally, the adjusting a filter strength on the filter unit based on magnitudes of the intra prediction cost and the inter prediction cost includes:
when the intra prediction cost is smaller relative to the inter prediction cost, reducing the filter strength on the filter unit; and
when the intra prediction cost is larger relative to the inter prediction cost, enhancing the filter strength on the filter unit.

Optionally, the adjusting a filter strength on the filter unit based on magnitudes of the intra prediction cost and the inter prediction cost includes:
when filtering all pixels belonging to the filter unit, multiplying a weight of a used filtering reference frame by one strength correction coefficient, wherein the strength correction coefficient is determined based on the magnitudes of the intra prediction cost and the inter prediction cost.

Optionally, the strength correction coefficient is determined based on the magnitudes of the intra prediction cost and the inter prediction cost in the filtering process includes:
the strength correction coefficient is negatively correlated with the intra prediction cost, and positively correlated with the inter prediction cost.

Optionally, the strength correction coefficient is S_k=min(2.0, ((a*QP*intraSatd+c)/(interSatd_k+c))\hat{ }2), wherein
a and c are empirical coefficients, QP is a quantization parameter, intraSatd is the intra prediction cost, and interSatd_k is the inter prediction cost based on a kth filtering reference frame of the filter unit.

Optionally, the inter prediction cost is a best motion vector cost generated by performing a motion search of motion-compensated temporal filtering MCTF on the filter unit.

Optionally, the obtaining an inter prediction cost in a filtering process includes:
after obtaining a motion compensation image based on a filtering reference frame of the filter unit, determining a distortion between the motion compensation image and an image before filtering by the filter unit, and using a distortion value as the inter prediction cost based on the filtering reference frame.

In addition, to achieve the foregoing objective, embodiments of this application further provide an image filter processing system. The system includes:
a collection module, configured to perform a Lookahead precoding on a to-be-processed image, and collect an intra prediction cost in Lookahead of a region covered by a current filter unit before filtering starts; and
a filter module, configured to perform a filter processing on the filter unit, obtain an inter prediction cost in a filtering process, and adjust a filter strength on the filter unit based on magnitudes of the intra prediction cost and the inter prediction cost.

To achieve the foregoing objective, embodiments of this application further provide an electronic apparatus. The electronic apparatus includes a memory, a processor, and an image filter processing program stored in the memory and capable of running on the processor. The image filter processing program implements the foregoing image filter processing method when being executed by the processor.

To achieve the foregoing objective, embodiments of this application further provide a computer-readable storage medium. The computer-readable storage medium stores an image filter processing program. The image filter processing program implements the foregoing image filter processing method when being executed by a processor.

To achieve the foregoing objective, embodiments of this application further provide a computer program product. The computer program product stores an image filter processing program. The image filter processing program implements the foregoing image filter processing method when being executed by a processor.

According to the image filter processing method and system, the electronic apparatus, and the computer-readable storage medium provided in the embodiments of the application, the intra prediction cost obtained in the Lookahead precoding and the inter prediction cost generated by the motion estimation in the MCTF can be used to estimate possibilities of the intra prediction and the inter prediction occurring in the region in actual coding, thereby correspondingly adjusting the strength of temporal filtering on the current filter unit, reducing a compression efficiency loss caused by error filtering, and improving an overall compression efficiency.

### BRIEF DESCRIPTION OF DRAWINGS

FIG. 1 is a diagram of an architecture of an application environment for implementing each embodiment of this application;

FIG. 2 is a flowchart of an image filter processing method according to Embodiment 1 of this application;

FIG. 3 is a schematic diagram of a filtered frame and a reference frame of a frame sequence;

FIG. 4 is a detailed schematic flowchart of step S202 in FIG. 2;

FIG. 5 is a schematic diagram of a hardware architecture of an electronic apparatus according to Embodiment 2 of this application; and

FIG. 6 is a schematic diagram of an image filter processing system according to Embodiment 3 of this application.

### DESCRIPTION OF EMBODIMENTS

To make the objectives, technical solutions, and advantages of this application clearer and more comprehensible, the following further describes this application in detail with reference to the accompanying drawings and embodiments. It should be understood that the specific embodiments described herein are merely used to explain this application but are not intended to limit this application. All other embodiments obtained by a person of ordinary skill in the art based on the embodiments of this application without creative efforts shall fall within the protection scope of this application.

It should be noted that the descriptions such as “first” and “second” in the embodiments of this application are merely used for description, and shall not be understood as an indication or implication of relative importance or an implicit indication of a quantity of indicated technical features. Therefore, a feature defined with “first” or “second” may explicitly or implicitly include at least one feature. In addition, the technical solutions in the embodiments may be combined with each other, provided that a person of ordinary skill in the art can implement the combination. When the combination of the technical solutions is contradictory or cannot be implemented, it should be considered that the combination of the technical solutions does not exist and does not fall within the protection scope of this application.

Explanations of terms involved in this application are provided below.

Versatile video coding (VVC) standard: it is a new-generation compression standard for video coding that is jointly formulated by the International Telecommunication Union and the International Organization for Standardization, aiming to provide higher compression performance and better video quality.

Motion-compensated temporal filtering (MCTF): it is a coding tool that performs in-advance filter processing on a video in an encoder to improve compression efficiency.

Lookahead precoding: it is a process of pre analyzing and processing a video in an encoder before coding starts. It usually refers to the use of an inter frame prediction technology to reduce a volume of data that needs to be coded when a video is coded. The technology reduces spatial redundancy by predicting a value of a current pixel based on surrounding pixels, aiming to improve a coding efficiency and increase a compression ratio.

Min group of pictures (mini-GOP): to better perform inter compression and control a frame rate and a bit rate, a concept of a group of pictures (GOP) is introduced into video compression. The GOP determines a sequence and an association between different frame types in a video bitstream. In addition, one GOP generally starts with an I frame. A quantity of frames between two adjacent I frames is a size of the GOP. The mini-GOP is a group of images, that contains a minimum quantity of images from a lowest layer to a highest layer, inside the GOP. A size of the mini-GOP is related to a frame reference relationship and a quantity of temporal layers during video coding.

Sum of absolute transformed differences (Sum of Absolute Transformed Differences, SATD): it is a standard for measuring a magnitude of a residual signal of a video. After a Hadmard transformation is performed on a difference between two pixel matrices, a sum of absolute values of transformation matrices is calculated to evaluate the difference between two pixel matrices.

Coding unit (CU): it is a basic unit for coding processes such as mode prediction, transformation, and quantization.

Largest coding unit (LCU): it is a basic unit for image partitioning, which may be further divided into CUs of different sizes.

Quantization parameter (QP): it is a parameter used to control a magnitude of a distortion in a quantization process.

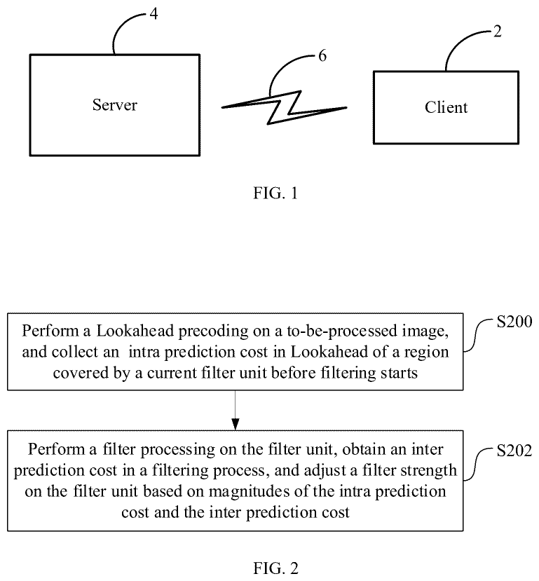

Referring to FIG. 1, FIG. 1 is a diagram of an architecture of an application environment for implementing each embodiment of the application. The application may be applied to an application environment that includes, but is not limited to, a client 2, a server 4, and a network 6.

The client 2 is configured to display an interface of a current application to a client computing device and receive operations of the client computing device, for example, operations such as uploading and selecting a video or an image. The client 2 may be a terminal device, for example, a personal computer (PC), a mobile phone, a tablet computer, a portable computer, or a wearable device.

The server 4 is configured to provide data and technical support for the client 2. The server 4 may be a computing device such as a rack server, a blade server, a tower server, or a cabinet server, may be an independent server, or may be a server cluster including a plurality of servers.

The network 6 may be a wireless or wired network, for example, an Intranet, the Internet, a global system of mobile communication (GSM), wideband code division multiple access (WCDMA), a 4G network, a 5G network, Bluetooth, or Wi-Fi. The server 4 is communicatively connected to one or more clients 2 by using the network 6, so as to perform data transmission and exchange.

### Embodiment 1

FIG. 2 is a flowchart of an image filter processing method according to Embodiment 1 of the application. It may be understood that the flowchart of the method in the embodiment is not used to limit a sequence of performing steps. Some steps in the flowchart may alternatively be added or deleted as required. The method may be performed by the client or the server, which is not limited herein.

The method includes the following steps:

S200: Perform a Lookahead precoding on a to-be-processed image, and collect an intra prediction cost in Lookahead of a region covered by a current filter unit before filtering starts.

The method provided in the embodiment is based on an encoder that implements Lookahead and MCTF algorithms. When coding, the encoder first performs a precoding processing on a current image in Lookahead, calculates parameters such as a frame structure and QP information of a sequence, and saves a precoded intra prediction cost during coding. Then a MCTF filter processing is performed on a precoded image.

In a current hybrid coding framework, each frame image in a video is first divided into largest coding units LCUs of a fixed size, and may be further divided into coding units CUs of variable sizes. For each CU, a predicted image is first obtained by using an inter or intra prediction technology. A difference between the predicted image and a raw image, also referred to as a residual, is transformed and quantized, and then sent to an entropy encoder for coding. Then through inverse quantization and inverse transformation, reconstruction is performed based on the predicted image. Finally, a reconstructed image is obtained through loop filtering. The reconstructed image may enter a coded (reconstructed) image buffer in the encoder as a reference image for inter prediction in a subsequent coding frame.

The encoder may further perform a Lookahead precoding process on a video before formal coding starts. In the process, multiple consecutive images of an input video are buffered to form a raw image queue. In the queue, by traversing combinations of different frame types and reference structures, precoding costs of the combinations are calculated, and a dynamic frame type decision is performed. In the cost calculation, an image may be generally divided into Lookahead units of a fixed size (for example, an 8×8 size), a simple intra prediction and inter prediction are performed on each Lookahead unit, and a sum of SATD costs is calculated. Generated coding information is saved to assist a subsequent formal coding process.

In the embodiment, after the Lookahead precoding is performed on the image and before filtering formally starts, an intra prediction cost intraSatd in Lookahead of the region covered by the current filter unit is collected. In the Lookahead precoding process, the image may obtain a best SATD of each Lookahead unit, and the intra prediction cost intraSatd is a sum of best SATDs of all Lookahead units in the region covered by the filter unit.

S202: Perform a filter processing on the filter unit, obtain an inter prediction cost in a filtering process, and adjust a filter strength on the filter unit based on magnitudes of the intra prediction cost and the inter prediction cost.

In the embodiment, the filter processing uses an MCTF algorithm. Before coding starts, relatively important frames (for example, I frames and P frames) in a mini-GOP of a frame sequence are selected as filtered frames. In addition, several front-to-back adjacent frames on a display sequence of the filtered frames are selected as reference frames.

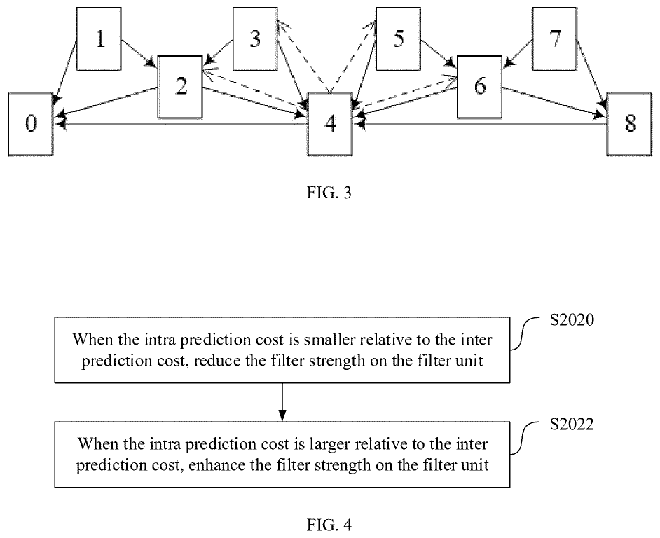

FIG. 3 is a schematic diagram of a filtered frame and a reference frame of a frame sequence. FIG. 3 shows a frame sequence with a length of 9 frames, and a solid line represents a reference direction of actual coding. For example, a 1st frame may bidirectionally reference to a 0th frame and a 2nd frame. The MCTF may select I frames and P frames such as 0th, 4th, and 8th frames, namely, filtered frames, for filtering. For example, when the 4th frame is filtered, four frames such as 2nd, 3rd, 5th, and 6th frames may be selected as filtering reference frame s to perform a motion estimation. It is noted that a motion estimation reference direction in the MCTF may be opposite to that in actual coding.

Then, the filtered frame is divided into filter units of a fixed size (for example, 16×16 or 32×32), and a motion search is successively performed on all reference frames for each filter unit to obtain a motion vector, and each pixel I in the filtered frame is weighted by using a motion compensation block based on the following formula:

$${I}^{′} ( x , y ) = ( I ( x , y ) + sum ( w\_k ( x , y ) * I\_k ( x + mvHor\_k ( x , y ) , y + mvVer\_k ( x , y ) ) ) / ( 1 + sum ( w\_k ( x , y ) ) ) ,$$

wherein
x and y represent current pixel positions, I_k represents an image of a kth filtering reference frame, mvHor_k and mvVer_k represent motion vectors of the kth filtering reference frame, and w_k represents a weight of the kth filtering reference frame. A magnitude of the weight depends on algorithm implementation. In the conventional technology, the weight is generally related to coding parameters such as a difference between a filtered frame pixel and a motion compensation pixel, a mini-GOP structure, and a QP.

However, in the embodiment, in order to adjust a strength of temporal filtering and then reduce a compression efficiency loss caused by error filtering, the weight calculated based on an original MCTF algorithm is corrected.

The inter prediction cost may also be referred to as a motion estimation cost, which is a best motion vector cost generated by performing the motion search of motion-compensated temporal filtering MCTF on the filter unit. After a motion compensation image is obtained based on the kth filtering reference frame of the filter unit, a distortion between the motion compensation image and an image before filtering by the filter unit is determined, and a distortion value is used as the inter prediction cost based on the filtering reference frame. In the embodiment, the distortion value is also represented by using SATD, the distortion value based on the kth filtering reference frame, that is, the inter prediction cost is interSatd_k.

Specifically, further referring to FIG. 4. FIG. 4 is a detailed schematic flowchart of the foregoing step S202. It may be understood that the flowchart is not used to limit a sequence of performing steps. Some steps in the flowchart may alternatively be added or deleted as required. In the embodiment, step S202 specifically includes:

S2020: When the intra prediction cost is smaller relative to the inter prediction cost, reduce the filter strength on the filter unit.

By comparing the magnitudes of the intra prediction cost and the inter prediction cost, possibilities of the intra prediction and the inter prediction occurring in actual coding may be estimated. If the intra prediction cost is smaller relative to the inter prediction cost, it indicates that a possibility that intra prediction occurs is high, and the strength of temporal filtering can be appropriately reduced, thereby reducing a compression efficiency loss caused by error filtering.

S2022: When the intra prediction cost is larger relative to the inter prediction cost, enhance the filter strength on the filter unit.

If the intra prediction cost is larger relative to the inter prediction cost, it indicates that a possibility that inter prediction occurs is high, and the strength of temporal filtering may be appropriately enhanced, thereby improving an overall compression efficiency.

A specific manner of adjusting the filter strength in the embodiment means when filtering all pixels belonging to the filter unit, multiplying a weight (that is, the foregoing weight w_k) of the used filtering reference frame by one strength correction coefficient. The strength correction coefficient is determined based on the magnitudes of the intra prediction cost and the inter prediction cost. Specifically, the strength correction coefficient is negatively correlated with the intra prediction cost, and positively correlated with the inter prediction cost.

In an optional embodiment, the strength correction coefficient (S_k) may be set based on the following formula:

$$S\_k = min ( 2. , ( ( a * QP * intraSatd + c ) / ( interSatd\_k + c ) ) \hat{} 2 ,$$

wherein
a and c are empirical coefficients, QP is a quantization parameter, intraSatd is the intra prediction cost, and interSatd_k is the inter prediction cost based on the kth filtering reference frame of the filter unit. In the embodiment, after multiple times of experimental study, the empirical coefficients a and c may be respectively 0.0125 and 64.

The constant value 2.0 is used to limit a magnitude of the strength correction coefficient, so as to avoid a problem in subsequent processing caused by an excessively large calculated result of the strength correction coefficient. That is, when the calculated result is less than or equal to 2.0, the strength correction coefficient is assigned to the calculated result. When the calculated result is greater than 2.0, the strength correction coefficient is directly assigned to 2.0.

When the intra prediction cost is smaller relative to the inter prediction cost, the strength correction coefficient is less than 1, thereby reducing filter strength of MCTF. On the contrary, when the intra prediction cost is larger relative to the inter prediction cost, the strength correction coefficient is greater than 1, thereby enhancing filter strength of MCTF.

In the embodiment, when all pixels belonging to the current filter unit are filtered, the following weight is used: W′_k (x, y)=w_k (x, y)*s_k. Another filter processing process in the embodiment is consistent with a filter processing process of an original MCTF algorithm, and details are not described herein again.

According to the image filter processing method provided in the embodiment of the application, the intra prediction cost obtained in the Lookahead precoding and the inter prediction cost generated by the motion estimation in the MCTF can be used to estimate possibilities of the intra prediction and the inter prediction occurring in the region in actual coding, thereby correspondingly adjusting the strength of temporal filtering on the current filter unit, reducing the compression efficiency loss caused by error filtering, and improving the overall compression efficiency.

### Embodiment 2

FIG. 5 is a schematic diagram of a hardware architecture of an electronic apparatus 20 according to Embodiment 2 of the application. In the embodiment, the electronic apparatus 20 may include, but is not limited to, a memory 21, a processor 22, and a network interface 23 that may be communicatively connected to each other by using a system bus. It should be noted that FIG. 5 merely shows the electronic apparatus 20 with components 21 to 23. However, it should be understood that implementation of all the shown components is not required, and more or fewer components may alternatively be implemented. In the embodiment, the electronic apparatus 20 may be an apparatus of the client or the server.

The memory 21 includes at least one type of readable storage medium. The readable storage medium includes a flash memory, a hard disk, a multimedia card, a card-type memory (for example, an SD memory or a DX memory), a random access memory (RAM), a static random access memory (SRAM), a read-only memory (ROM), an electrically erasable programmable read-only memory (EEPROM), a programmable read-only memory (PROM), a magnetic memory, a magnetic disk, an optical disc, and the like. In some embodiments, the memory 21 may be an internal storage unit of the electronic apparatus 20, for example, a hard disk or a memory of the electronic apparatus 20. In some other embodiments, the memory 21 may alternatively be an external storage device of the electronic apparatus 20, for example, a removable hard disk, a smart media card (SMC), a secure digital (SD) card, or a flash card that is disposed on the electronic apparatus 20. Certainly, the memory 21 may include both an internal storage unit of the electronic apparatus 20 and an external storage device thereof. In the embodiment, the memory 21 is usually configured to store an operating system and various types of application software that are installed in the electronic apparatus 20, for example, program code of an image filter processing system 60. In addition, the memory 21 may be further configured to temporarily store various types of data that have been output or are to be output.

The processor 22 may be a central processing unit (CPU), a controller, a microcontroller, a microprocessor, or another data processing chip in some embodiments. The processor 22 is usually configured to control an overall operation of the electronic apparatus 20. In the embodiment, the processor 22 is configured to run the program code stored in the memory 21 or process data, for example, run the image filter processing system 60.

The network interface 23 may include a wireless network interface or a wired network interface, and the network interface 23 is usually configured to establish a communication connection between the electronic apparatus 20 and another electronic device.

### Embodiment 3

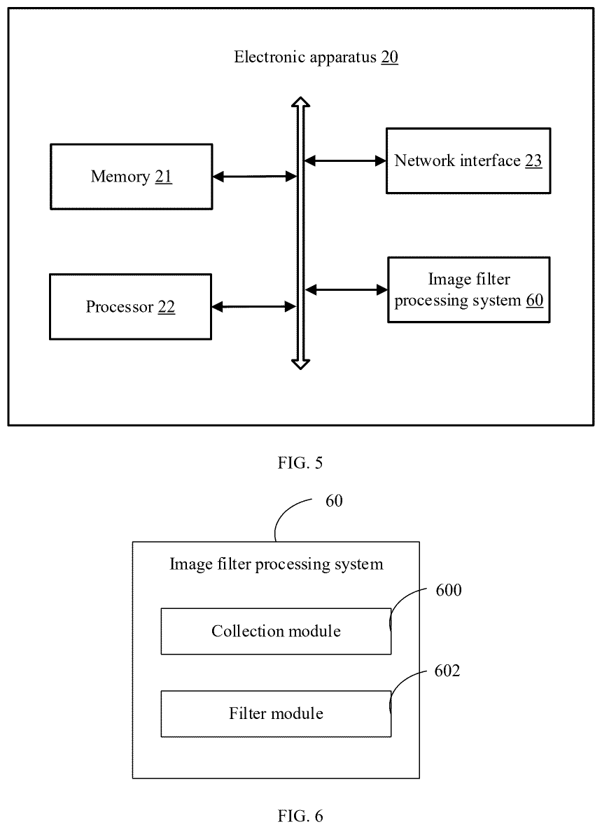

FIG. 6 is a schematic diagram of an image filter processing system 60 according to Embodiment 3 of the application. The image filter processing system 60 may be partitioned into one or more program means. The one or more program means are stored in a storage medium and executed by one or more processors, to complete the embodiment of the application. The program means in the embodiment of the application is a series of computer program instruction segments that can be used to complete a specified function. A function of each program means in the embodiment is to be described in detail below.

In the embodiment, the image filter processing system 60 includes:
a collection module 600, configured to perform a Lookahead precoding on a to-be-processed image, and collect an intra prediction cost in Lookahead of a region covered by a current filter unit before filtering starts.

In the embodiment, an encoder implementing the Lookahead and MCTF algorithms is used. When coding, the encoder first performs a precoding processing on a current image in the Lookahead, calculates parameters such as a frame structure and QP information of a sequence, and saves a precoded intra prediction cost during coding. Then MCTF filter processing is performed on a precoded image.

In the embodiment, after the Lookahead precoding is performed on the image and before filtering formally starts, an intra prediction cost intraSatd in Lookahead of the region covered by the current filter unit is collected. In a Lookahead precoding process, the image may obtain a best SATD of each Lookahead unit, and the intra prediction cost intraSatd is a sum of best SATDs of all Lookahead units in the region covered by the filter unit.

A filter module 602 is configured to perform a filter processing on the filter unit, obtain an inter prediction cost in a filtering process, and adjust a filter strength on the filter unit based on magnitudes of the intra prediction cost and the inter prediction cost.

In the embodiment, the filter processing uses an MCTF algorithm. Before coding starts, relatively important frames (for example, I frames and P frames) in a mini-GOP of a frame sequence are selected as filtered frames. In addition, several front-to-back adjacent frames on a display sequence of the filtered frames are selected as reference frames.

Then, the filtered frame is divided into filter units of a fixed size (for example, 16×16 or 32×32), and a motion search is successively performed on all reference frames for each filter unit to obtain a motion vector, and each pixel I in the filtered frame is weighted by using a motion compensation block based on the following formula:

$${I}^{′} ( x , y ) = ( I ( x , y ) + sum ( w\_k ( x , y ) * I\_k ( x + mvHor\_k ( x , y ) , y + mvVer\_k ( x , y ) ) ) / ( 1 + sum ( w\_k ( x , y ) ) ) ,$$

wherein
x and y represent current pixel positions, I_k represents an image of a kth filtering reference frame, mvHor_k and mvVer_k represent motion vectors of the kth filtering reference frame, and w_k represents a weight of the kth filtering reference frame. A magnitude of the weight depends on algorithm implementation. In the conventional technology, the weight is generally related to coding parameters such as a difference between a filtered frame pixel and a motion compensation pixel, a mini-GOP structure, and a QP.

However, in the embodiment, in order to adjust a strength of temporal filtering and then reduce a compression efficiency loss caused by error filtering, the weight calculated based on an original MCTF algorithm is corrected.

The inter prediction cost may also be referred to as a motion estimation cost, which is a best motion vector cost generated by performing the motion search of motion-compensated temporal filtering MCTF on the filter unit. After a motion compensation image is obtained based on the kth filtering reference frame of the filter unit, a distortion between the motion compensation image and an image before filtering by the filter unit is determined, and a distortion value is used as the inter prediction cost based on the filtering reference frame. In the embodiment, the distortion value is also represented by using SATD, the distortion value based on the kth filtering reference frame, that is, the inter prediction cost is interSatd_k.

Based on the magnitudes of the intra prediction cost and the inter prediction cost, the filter strength on the filter unit is correspondingly adjusted. When the intra prediction cost is smaller relative to the inter prediction cost, the filter strength on the filter unit is reduced. When the intra prediction cost is larger relative to the inter prediction cost, the filter strength on the filter unit is enhanced.

By comparing the magnitudes of the intra prediction cost and the inter prediction cost, possibilities of the intra prediction and the inter prediction occurring in actual coding may be estimated. If the intra prediction cost is smaller relative to the inter prediction cost, it indicates that a possibility that intra prediction occurs is high, and the strength of temporal filtering can be appropriately reduced, thereby reducing a compression efficiency loss caused by error filtering.

If the intra prediction cost is larger relative to the inter prediction cost, it indicates that a possibility that inter prediction occurs is high, and the strength of temporal filtering may be appropriately enhanced, thereby improving an overall compression efficiency.

A specific manner of adjusting the filter strength in the embodiment means when filtering all pixels belonging to the filter unit, multiplying a weight (that is, the foregoing weight w_k) of the used filtering reference frame by one strength correction coefficient. The strength correction coefficient is determined based on the magnitudes of the intra prediction cost and the inter prediction cost. Specifically, the strength correction coefficient is negatively correlated with the intra prediction cost, and positively correlated with the inter prediction cost.

In an optional embodiment, the strength correction coefficient (S_k) may be set based on the following formula:

$$S\_k = min ( 2. , ( ( a * QP * intraSatd + c ) / ( interSatd\_k + c ) ) \hat{} 2 ,$$

wherein
a and c are empirical coefficients, QP is a quantization parameter, intraSatd is the intra prediction cost, and interSatd_k is the inter prediction cost based on a kth filtering reference frame of the filter unit. In the embodiment, after multiple times of experimental study, the empirical coefficients a and c may be respectively 0.0125 and 64.

When the intra prediction cost is smaller relative to the inter prediction cost, the strength correction coefficient is less than 1, thereby reducing filter strength of MCTF. On the contrary, when the intra prediction cost is larger relative to the inter prediction cost, the strength correction coefficient is greater than 1, thereby enhancing filter strength of MCTF.

In the embodiment, when filtering is performed on all pixels belonging to the current filter unit, the following weight is used: W′_k (x, y)=w_k (x, y)*s_k. Another filter processing process in the embodiment is consistent with a filter processing process of an original MCTF algorithm, and details are not described herein again.

According to the image filter processing system provided in the embodiment of the application, the intra prediction cost obtained in the Lookahead precoding and the inter prediction cost generated by the motion estimation in the MCTF can be used to estimate possibilities of the intra prediction and the inter prediction occurring in the region in actual coding, thereby correspondingly adjusting the strength of temporal filtering on the current filter unit, reducing the compression efficiency loss caused by error filtering, and improving the overall compression efficiency.

### Embodiment 4

The application further provides another implementation, that is, provides a computer-readable storage medium. The computer-readable storage medium stores an image filter processing program. The image filter processing program may be executed by at least one processor, so that the at least one processor performs steps of the foregoing image filter processing method.

In the embodiment, the computer-readable storage medium includes a flash memory, a hard disk, a multimedia card, a card-type memory (for example, an SD memory or a DX memory), a random access memory (RAM), a static random access memory (SRAM), a read-only memory (ROM), an electrically erasable programmable read-only memory (EEPROM), a programmable read-only memory (PROM), a magnetic memory, a magnetic disk, an optical disc, and the like. In some embodiments, the computer-readable storage medium may be an internal storage unit of a computer device, for example, a hard disk or an internal memory of the computer device. In some other embodiments, the computer-readable storage medium may alternatively be an external storage device of the computer device, for example, a removable hard disk, a smart media card (SMC), a secure digital (SD) card, or a flash card that is disposed on the computer device. Certainly, the computer-readable storage medium may alternatively include both an internal storage unit of the computer device and an external storage device of the computer device. In the embodiment, the computer-readable storage medium is usually configured to store an operating system and various types of application software that are installed on the computer device, for example, program code of the image filter processing method in the embodiments. In addition, the computer-readable storage medium may be further configured to temporarily store various types of data that have been output or are to be output.

### Embodiment 5

The application further provides a computer program product. The computer program product stores an image filter processing program. The image filter processing program may be executed by at least one processor, so that the at least one processor performs steps of the foregoing image filter processing method.

It should be noted that in the specification, the term “include”, “contain”, or any other variant thereof is intended to cover non-exclusive inclusion, so that a process, method, article, or apparatus that includes a series of elements includes those elements and other elements that are not explicitly listed or elements inherent to the process, method, article, or apparatus. In the absence of more restrictions, the element defined with the statement “includes a . . . ” does not exclude the existence of another identical element in the process, method, article, or apparatus that includes the element.

The serial numbers of the foregoing embodiments of the application are merely for illustrative purposes, and are not intended to indicate priorities of the embodiments.

Clearly, a person skilled in the art should understand that the foregoing modules or steps in the embodiments of the application may be implemented by using a general computing apparatus. The modules or steps may be integrated into a single computing apparatus or distributed in a network including a plurality of computing apparatuses. Optionally, the modules or steps may be implemented by using program code that can be executed by the computing apparatus. Therefore, the modules or steps may be stored in a storage apparatus for execution by the computing apparatus. In addition, in some cases, the shown or described steps may be performed in an order different from the order herein. Alternatively, the modules or steps are separately made into integrated circuit modules, or a plurality of modules or steps in the modules or steps are made into a single integrated circuit modules for implementation. In this way, a combination of any specific hardware and software is not limited in the embodiments of the application.

The foregoing descriptions are merely preferred embodiments in the embodiments of the application, and are not intended to limit the patent scope of the embodiments of the application. Any equivalent structure or equivalent procedure change that is made by using the content of the specification and the accompanying drawings of the embodiments of the application or that is directly or indirectly applied to other related technical fields shall also fall within the patent protection scope of the embodiments of the application.

What is claimed is:

1. An image filter processing method, comprising:
performing a Lookahead precoding on a to-be-processed image, and collecting an intra prediction cost in Lookahead of a region covered by a current filter unit before filtering starts; and
performing a filter processing on the filter unit, obtaining an inter prediction cost in a filtering process, and adjusting a filter strength on the filter unit based on magnitudes of the intra prediction cost and the inter prediction cost.

2. The image filter processing method according to claim 1, wherein the adjusting a filter strength on the filter unit based on magnitudes of the intra prediction cost and the inter prediction cost comprises:
when the intra prediction cost is smaller relative to the inter prediction cost, reducing the filter strength on the filter unit; and
when the intra prediction cost is larger relative to the inter prediction cost, enhancing the filter strength on the filter unit.

3. The image filter processing method according to claim 1, wherein the adjusting a filter strength on the filter unit based on magnitudes of the intra prediction cost and the inter prediction cost comprises:
when filtering all pixels belonging to the filter unit, multiplying a weight of a used filtering reference frame by one strength correction coefficient, wherein the strength correction coefficient is determined based on the magnitudes of the intra prediction cost and the inter prediction cost.

4. The image filter processing method according to claim 3, wherein the strength correction coefficient is determined based on the magnitudes of the intra prediction cost and the inter prediction cost in the filtering process comprises:
the strength correction coefficient is negatively correlated with the intra prediction cost, and positively correlated with the inter prediction cost.

5. The image filter processing method according to claim 4, wherein
the strength correction coefficient is S_k=min(2.0, ((a*QP*intraSatd+c)/(interSatd_k+c))\hat{ }2), wherein
a and c are empirical coefficients, QP is a quantization parameter, intraSatd is the intra prediction cost, and interSatd_k is the inter prediction cost based on a kth filtering reference frame of the filter unit.

6. The image filter processing method according to claim 1, wherein the inter prediction cost is a best motion vector cost generated by performing a motion search of motion-compensated temporal filtering MCTF on the filter unit.

7. The image filter processing method according to claim 1, wherein the obtaining an inter prediction cost in a filtering process comprises:
after obtaining a motion compensation image based on a filtering reference frame of the filter unit, determining a distortion between the motion compensation image and an image before filtering by the filter unit, and using a distortion value as the inter prediction cost based on the filtering reference frame.

8. An electronic device, comprising a memory, a processor, and an image filter processing program stored in the memory and capable of running on the processor, wherein the image filter processing program, when executed by the processor, causes the processor to implement operations comprising:
performing a Lookahead precoding on a to-be-processed image, and collecting an intra prediction cost in Lookahead of a region covered by a current filter unit before filtering starts; and
performing a filter processing on the filter unit, obtaining an inter prediction cost in a filtering process, and adjusting a filter strength on the filter unit based on magnitudes of the intra prediction cost and the inter prediction cost.

9. The electronic device according to claim 8, wherein the adjusting a filter strength on the filter unit based on magnitudes of the intra prediction cost and the inter prediction cost comprises:
when the intra prediction cost is smaller relative to the inter prediction cost, reducing the filter strength on the filter unit; and
when the intra prediction cost is larger relative to the inter prediction cost, enhancing the filter strength on the filter unit.

10. The electronic apparatus according to claim 8, wherein the adjusting a filter strength on the filter unit based on magnitudes of the intra prediction cost and the inter prediction cost comprises:
when filtering all pixels belonging to the filter unit, multiplying a weight of a used filtering reference frame by one strength correction coefficient, wherein the strength correction coefficient is determined based on the magnitudes of the intra prediction cost and the inter prediction cost.

11. The electronic apparatus according to claim 10, wherein the strength correction coefficient is determined based on the magnitudes of the intra prediction cost and the inter prediction cost in the filtering process comprises:
the strength correction coefficient is negatively correlated with the intra prediction cost, and positively correlated with the inter prediction cost.

12. The electronic apparatus according to claim 11, wherein
the strength correction coefficient is S_k=min(2.0, ((a*QP*intraSatd+c)/(interSatd_k+c))\hat{ }2), wherein
a and c are empirical coefficients, QP is a quantization parameter, intraSatd is the intra prediction cost, and interSatd_k is the inter prediction cost based on a kth filtering reference frame of the filter unit.

13. The electronic apparatus according to claim 8, wherein the inter prediction cost is a best motion vector cost generated by performing a motion search of motion-compensated temporal filtering MCTF on the filter unit.

14. The electronic apparatus according to claim 8, wherein the obtaining an inter prediction cost in a filtering process comprises:
after obtaining a motion compensation image based on a filtering reference frame of the filter unit, determining a distortion between the motion compensation image and an image before filtering by the filter unit, and using a distortion value as the inter prediction cost based on the filtering reference frame.

15. A non-transitory computer-readable storage medium, wherein the computer-readable storage medium stores an image filter processing program, and the image filter processing program, when executed by a computing device, causes the computing device to implement operations comprising:
performing a Lookahead precoding on a to-be-processed image, and collecting an intra prediction cost in Lookahead of a region covered by a current filter unit before filtering starts; and
performing a filter processing on the filter unit, obtaining an inter prediction cost in a filtering process, and adjusting a filter strength on the filter unit based on magnitudes of the intra prediction cost and the inter prediction cost.

16. The non-transitory computer-readable storage medium according to claim 15, wherein the adjusting a filter strength on the filter unit based on magnitudes of the intra prediction cost and the inter prediction cost comprises:
when the intra prediction cost is smaller relative to the inter prediction cost, reducing the filter strength on the filter unit; and
when the intra prediction cost is larger relative to the inter prediction cost, enhancing the filter strength on the filter unit.

17. The non-transitory computer-readable storage medium according to claim 15, wherein the adjusting a filter strength on the filter unit based on magnitudes of the intra prediction cost and the inter prediction cost comprises:
when filtering all pixels belonging to the filter unit, multiplying a weight of a used filtering reference frame by one strength correction coefficient, wherein the strength correction coefficient is determined based on the magnitudes of the intra prediction cost and the inter prediction cost.

18. The non-transitory computer-readable storage medium according to claim 17, wherein the strength correction coefficient is determined based on the magnitudes of the intra prediction cost and the inter prediction cost in the filtering process comprises:
the strength correction coefficient is negatively correlated with the intra prediction cost, and positively correlated with the inter prediction cost.
